(19) United States
(12) Patent Application Publication
(10) Pub. No.: US 2013/0323610 A1
(43) Pub. Date: Dec. 5, 2013

(54) MANUFACTURING METHOD OF OXYGEN REDUCTION REACTION CATALYSTS AND CATALYSTS THEREOF, CATHODE USING OXYGEN REDUCTION REACTION CATALYSTS

(71) Applicants: UNIST Academy-Industry Research Corporation, Ulsan (KR); HYUNDAI HEAVY INDUSTRIES CO., LTD., Ulsan (KR)

(72) Inventors: Jung-Yun KIM, Gyeongsangnam-do (KR); Ho-Il Lee, Ulsan (KR); Jae-Phil Cho, Ulsan (KR); Jang-Soo Lee, Seoul (KR)

(21) Appl. No.: 13/904,525

(22) Filed: May 29, 2013

(30) Foreign Application Priority Data
May 29, 2012 (KR) 10-2012-0056623
May 20, 2013 (KR) 10-2013-0056473

(51) Int. Cl. H01M 4/90

(52) U.S. Cl. CPC H01M 4/9075
USPC 429/406; 502/167; 429/405

(57) ABSTRACT

This invention relates to a method of preparing an oxygen reduction reaction catalyst, an oxygen reduction reaction catalyst prepared thereby, and an electrode for a metal-air battery using the oxygen reduction reaction catalyst, wherein transition metal ions are adsorbed on a commercially available melamine foam and carbonized, and carbon black is supported on a porous structure of the carbonized melamine foam support, thereby economically preparing the oxygen reduction reaction catalyst that is able to maximize an effect of promoting the oxygen reduction reaction.

### BACKGROUND OF THE INVENTION

1. Field of the Invention

The present invention relates to a method of preparing an oxygen reduction reaction catalyst, an oxygen reduction reaction catalyst prepared thereby, and an electrode for a metal-air battery using the oxygen reduction reaction catalyst, and more particularly, to a method of preparing an oxygen reduction reaction catalyst, an oxygen reduction reaction catalyst prepared thereby, and an electrode for a metal-air battery using the oxygen reduction reaction catalyst, wherein a melamine foam which is commercially available is introduced with transition metal ions, carbonized to make carbon-nitrogen-transition metal reaction sites, and mixed with carbon black which is to be placed in the macropores of the carbonized melamine foam, thereby preparing the oxygen reduction reaction catalyst having high efficiency.

2. Description of the Related Art

With the exhaustion of fossil fuels and the increasing demand for eco-friendly and highly efficient alternative energy, metal-air batteries are receiving much attention. Most of the materials used in these batteries are eco-friendly and inexpensive and are likely to be considerably developed, making it possible to design batteries having ultrahigh capacities in the future.

Among metal-air batteries, a zinc-air battery is currently utilized in hearing aids or small-capacity devices and is being applied to secondary batteries thereof. A zinc-air battery includes an anode made of zinc (Zn) powder or a zinc plate. In the case of zinc powder, the anode may be manufactured by increasing formability of zinc powder, using a paste comprising zinc powder, an aqueous alkaline electrolyte and a gelling agent, which are mixed together.

The cathode of the zinc-air battery is configured to include a catalyst layer, a diffusion layer, and a hydrophobic membrane, wherein the catalyst layer is composed of a catalyst, a catalyst support, a conductive material, etc., and the diffusion layer includes activated carbon for providing flow paths of oxygen, and a hydrophobic binder (polytetrafluoroethylene (PTFE), etc.) to ensure formability of activated carbon and to maintain hydrophobicity of the cathode. The diffusion layer may be formed by compressing them on a metal screen or metal foam, or by using carbon paper, carbon fibers, etc.

A zinc-air battery consists of an anode comprising a zinc gel or a zinc plate, a polymer separator comprising polypropylene (PP), a nylon filter or polyethylene (PE), having ion permeability, to separate the anode from a cathode and, a catalyst layer containing a catalyst and carbon which reacts with oxygen in air to cause a cathode reaction, a diffusion layer comprising carbon and a binder or comprising carbon paper or carbon fibers, a metal layer having electronic conductivity, a PTFE hydrophobic membrane for preventing introduction of external moisture to lengthen lifetime of a battery, and a diffusion layer for uniformly diffusing external air.

The following Reaction 1 shows an embodiment where the anode of the metal-air battery is composed of zinc. As such, when other metals are used in the anode, instead of zinc, a variety of reactions for metal-air batteries may naturally result.

Cathode: O₂+2H₂O+4e→4OH⁻

Anode: 2Zn+4OH⁻>2ZnO+2H₂O+4e⁻

Overall: 2Zn+O₂→2ZnO

Because a zinc-air battery includes oxygen in air as the cathode active material, as well as the lightweight carbon material for the cathode, the weight of the battery may be decreased, making it possible to achieve higher energy density compared to a lithium-ion battery.

However, because the oxygen reduction reaction is much slower than the rate of oxidation of the metal anode, the overall reaction of the battery depends on the rate of oxygen reduction reaction of the cathode.

Hence, a zinc-air battery having high output and high energy density requires an effective oxygen reduction reaction catalyst. To this end, the catalyst support is mainly exemplified by expensive carbon nanotubes, or graphene the preparation process of which is very complicated. An expensive noble metal catalyst using such a catalyst support has superior performance but its price is very high, and thus profitability which is the major advantage of the zinc-air battery undesirably disappears. Accordingly, in the case of a typical zinc-air battery, thorough research is ongoing into metal oxides (manganese, cobalt, iron, etc.), and metal-free catalysts corresponding to carbon materials having substituted nitrogen. However, the process of preparing carbon having substituted nitrogen is considerably complicated, undesirably making it difficult to synthesize a desired material.

### CITATION LIST

### Patent Literature

(Patent Document 1) Korean Unexamined Patent Publication No. 10-2010-0122706 (2010 Nov. 23.)
(Patent Document 2) Korean Unexamined Patent Publication No. 10-2011-0105051 (2011 Sep. 26.)
(Patent Document 3) Korean Patent No. 10-0875105 (2008 Dec. 15)

### SUMMARY OF THE INVENTION

Therefore, the present invention has been made keeping in mind the above problems occurring in the related art, and an object of the present invention is to provide a method of preparing an oxygen reduction reaction catalyst and an oxygen reduction reaction catalyst for a metal-air battery prepared thereby, wherein transition metal ions are adsorbed on a commercially available melamine foam support and carbonized, and carbon black is supported on the porous structure of the carbonized melamine foam support, thereby economically preparing the oxygen reduction reaction catalyst that is able to maximize an effect of promoting the oxygen reduction reaction.

Another object of the present invention is to provide an electrode for a metal-air battery using the above composite catalyst.

In order to accomplish the above objects, an aspect of the present invention provides an oxygen reduction reaction catalyst, comprising a melamine foam support containing carbonized transition metal ions; and carbon black supported on the melamine foam support.

In a preferred embodiment, the oxygen reduction reaction catalyst may comprise 50˜80 wt % of the melamine foam support containing carbonized transition metal ions and 20˜50 wt % of the carbon black.

In a preferred embodiment, the transition metal ions may be contained in an amount of 1˜10 wt % based on total wt % of a carbonized melamine foam.

In a preferred embodiment, the transition metal ions may be iron ions or cobalt ions.

In a preferred embodiment, the iron ions may be formed by carbonizing an iron ion complex aqueous solution including any one or more selected from among FeCl₂.4H₂O, FeCl₃.6H₂O and Fe(NO₃)₃.6H₂O in the melamine foam.

In a preferred embodiment, the cobalt ions may be formed by carbonizing a cobalt ion complex aqueous solution including any one or more selected from among Co(NO₃)₂₋₆H₂O and Co(C₂H₃O₂)₂ in the melamine foam.

In a preferred embodiment, the carbon black may include one or more selected from among denka black, acetylene black, ketjen black, furnace black, thermal black and lamp black.

Another aspect of the present invention provides an electrode for a metal-air battery, comprising the oxygen reduction reaction catalyst as above, activated carbon and a binder, which are mixed together.

In a preferred embodiment, the anode of the metal-air battery may include zinc or lithium.

A further aspect of the present invention provides a method of preparing the oxygen reduction reaction catalyst, comprising a) cutting a melamine foam to a catalyst size as required; b) preparing a transition metal ion complex aqueous solution; c) impregnating the melamine foam with the transition metal ion complex aqueous solution; d) drying the melamine foam impregnated with the transition metal ion complex aqueous solution; e) thermally treating the dried melamine foam in an inert gas atmosphere so as to be carbonized; and f) mixing the carbonized melamine foam with carbon black at a predetermined ratio, thus preparing a final catalyst.

In a preferred embodiment, f) may be performed by physically mixing 50˜80 wt % of a melamine foam support containing carbonized transition metal ions and 20˜50 wt % of carbon black.

In a preferred embodiment, transition metal ions may be contained in an amount of 1˜10 wt % based on total wt % of the carbonized melamine foam.

In a preferred embodiment, d) may be performed by drying the impregnated melamine foam at 40˜50° C. for 24 hr or longer.

In a preferred embodiment, e) may be performed by carbonizing the dried melamine foam at 600˜900° C. for 1˜2 hr in an inert gas atmosphere.

In a preferred embodiment, the transition metal ion complex aqueous solution may be an iron ion complex aqueous solution or a cobalt ion complex aqueous solution.

In a preferred embodiment, the iron ion complex aqueous solution may include any one or more selected from among FeCl₂.4H₂O, FeCl₃.6H₂O and Fe(NO₃)₃.6H₂O.

In a preferred embodiment, the cobalt ion complex aqueous solution may include any one or more selected from among Co(NO₃)₂.6H₂O and Co(C₂H₃O₂)₂.

In a preferred embodiment, the carbon black may include one or more selected from among denka black, acetylene black, ketjen black, furnace black, thermal black and lamp black.

### BRIEF DESCRIPTION OF THE DRAWINGS

The above and other objects, features and advantages of the present invention will be more clearly understood from the following detailed description taken in conjunction with the accompanying drawings, in which:

FIG. 1 illustrates a process of preparing a composite catalyst comprising an iron ion-functionalized melamine foam and ketjen black according to an embodiment of the present invention;

FIG. 2 illustrates scanning electron microscope (SEM) images of the composite catalyst prepared according to the embodiment of the present invention (the carbonized iron ion-functionalized melamine foam (left) and the prepared composite catalyst of melamine foam and ketjen black (right)); and

FIG. 3 illustrates a graph of linear sweep voltammetry of the catalyst prepared in an oxygen saturation atmosphere according to the embodiment of the present invention.

### DESCRIPTION OF SPECIFIC EMBODIMENTS

Hereinafter, a detailed description will be given of the present invention with reference to the appended drawings. In the following description, it is to be noted that, when known techniques related to the present invention may make the gist of the present invention unclear, a detailed description thereof will be omitted.

According to the present invention, a method of preparing an oxygen reduction reaction catalyst is provided, which includes adsorbing transition metal ions on a porous melamine foam which naturally contains a large amount of substituted nitrogen in a carbon backbone and has a three-dimensional macropore structure, burning the melamine foam at a high temperature in an inert gas atmosphere to make a carbonized melamine foam containing a large amount of carbon-nitrogen-transition metal corresponding to the actual reaction sites, and simply physically mixing the prepared foam with carbon black, thereby preparing the catalyst in which the effect of promoting the oxygen reduction reaction is maximized.

Specifically, in the present invention, there is developed a method using a simple one-pot reaction wherein a melamine foam, which is a polymer originally containing nitrogen and is commercially available, is additionally introduced with transition metal ions to maximize a catalytic effect, and burned at a high temperature in an inert gas atmosphere so as to be carbonized, thereby solving conventional synthesis problems and maximizing the catalytic effect. Further, because the three-dimensional structure of only the melamine foam is left behind even after the carbonization process, carbon black, which is an inexpensive conductive carbon and is widely available, is placed in macropores of the melamine foam, ultimately enabling the effective preparation of the oxygen reduction reaction catalyst.

According to the present invention, the method of preparing such a catalyst includes a) preparing a melamine foam; b) preparing a transition metal ion complex aqueous solution; c) impregnating the melamine foam with the transition metal ion complex aqueous solution; d) drying the melamine foam impregnated with the transition metal ion complex aqueous solution; e) thermally treating the dried melamine foam in an inert gas atmosphere so as to be carbonized; and f) mixing the carbonized melamine foam having a porous structure with carbon black at a predetermined ratio, thereby preparing a final catalyst.

In the method, a) preparing the melamine foam and b) preparing the transition metal ion complex aqueous solution may be performed regardless of the sequence, because these steps do not have a reciprocal relationship.

The preparation steps after c) may be sequentially carried out.

The melamine foam, which is commonly used for dish washing or other cleaning tasks in the home, is configured to naturally contain a large amount of substituted nitrogen in a carbon backbone, and to have a three-dimensional structure, and the melamine foam has pores having a size of about 100 μm. In an embodiment of the present invention, a magic block commercially available from BASF, Germany, is useful as the melamine foam. In addition thereto, any melamine foam may be used.

Melamine of the melamine foam is an organic base as a heterocyclic amine, and a cyanamide trimer. The melamine is composed of 66 mass % of nitrogen, and may exhibit flame resistance when mixed with a resin.

The melamine foam may have a size of about 110 mm (width)*270 mm (length)*40 mm (height), typically based on an extra large size, and may be used by being cut to a size of about 50 mm*50 mm*40 mm as required. However, these sizes are merely illustrative, and the melamine foam may be cut to any necessary arbitrary size.

The transition metal ion complex aqueous solution may include an iron ion complex aqueous solution or a cobalt ion complex aqueous solution. The iron ion complex aqueous solution may include any one or more selected from among FeCl₂.4H₂O, FeCl₃.6H₂O, and Fe(NO₃)₃.6H₂O, and the cobalt ion complex aqueous solution may include any one or more selected from among Co(NO₃)₂.6H₂O and Co(C₂H₃O₂)₂.

The concentration of the transition metal ion complex aqueous solution is preferably set to 5˜20 mM. If the concentration thereof is less than the above lower limit, the rate of adsorption of transition metal ions is low, undesirably decreasing the catalytic efficiency. In contrast, if the concentration thereof exceeds the above upper limit, the transition metal ions may be completely adsorbed and are not further adsorbed.

For reference, in the case of iron ions, 1.1 g of melamine foam is immersed in 50 mL of a 5 mM FeCl₂.4H₂O aqueous solution so as to be sufficiently absorbed.

Specifically, the mixing ratio (wt %) of iron ion complex contained in the 5˜20 mM FeCl₂.4H₂O aqueous solution to melamine may be set to 0.56˜2.25:1.

In the above numeral range, the melamine foam according to the present invention is impregnated with the transition metal ions able to optimally exhibit catalytic performance thereof. In the case of such an impregnation ratio, the amount of the transition metal ions may be 1˜10 wt % based on the total wt % of the carbonized melamine foam. If the amount of the transition metal ions falls outside of the above range, catalytic performance may deteriorate.

Drying the melamine foam is performed in such a manner that the melamine foam impregnated with the transition metal ion complex at room temperature (25° C.) is sufficiently dried at 40˜50° C. for 24 hr or longer. In this temperature range, the melamine foam may be sufficiently dried without changes in properties due to drying.

If the melamine foam which is not sufficiently dried is burned at a high temperature (900° C.) in an inert gas atmosphere, the entire melamine foam may be burned.

Thermally treating the dried melamine foam so as to be carbonized should be performed in an inert gas atmosphere such as a nitrogen atmosphere or an argon atmosphere. When the melamine foam is burned in air, it is never carbonized, but is thoroughly converted into CO₂, which is then volatilized in air.

The inert gas includes not only inert gas belonging to Group 18 on the periodic table but also any gas such as nitrogen, which doe not participate in the reaction under the above conditions.

As the thermal treatment temperature is higher and the thermal treatment time is longer, N (nitrogen) content may typically decrease. If the N content becomes lower, the number of sites on which Fe ions may be adsorbed may be decreased, undesirably deteriorating oxygen reduction reaction (ORR) performance. Hence, the best carbonization performance may be obtained at a thermal treatment temperature of 600˜900° C. Also, when the burning time is 1˜2 hr, the carbonization is completed.

Upon mixing the carbonized melamine foam having a porous structure with carbon black at a predetermined ratio to prepare a final catalyst, the mixing ratio of the carbonized melamine foam support and the carbon black supported thereon is set such that 50˜80 wt % of the carbonized melamine foam and 20˜50 wt % of the carbon black are mixed based on the wt % of the prepared catalyst. If the amount of carbon black is less than 20 wt %, conductivity may decrease, undesirably deteriorating catalytic performance. In contrast, if the amount thereof exceeds 50 wt %, the effect of the melamine catalyst may deteriorate due to an excess of carbon black, resulting in poor catalytic performance.

The carbon black may include one or more selected from among denka black, acetylene black, ketjen black, furnace black, thermal black, and lamp black.

An example of carbon black used in the present invention is commercially available Ketjenblack 600-JD which is a conductive material, the price of which is much lower than that of expensive carbon nanotubes.

The carbonization and the catalyst preparation may be carried out by powdering the carbonized melamine foam, and mixing the powder with about 20-50 wt % of carbon black, thereby preparing a final catalyst.

A method of applying the catalyst (lump or powder) prepared as above to an electrode for a metal-air battery is described below. As used herein, the metal-air battery may be a zinc-air battery or a lithium-air battery using zinc or lithium as a metal for the anode.

Typically, a method of manufacturing a cathode includes mixing activating carbon, the composite catalyst according to the present invention and a binder at a predetermined ratio to prepare a paste, which is then applied.

Specifically, the method of manufacturing the cathode for a metal-air battery according to the present invention is described as follows.

1. Preparing Slurry

The composite catalyst prepared by the catalyst preparation method according to the present invention is mixed with a carbon support able to support it and a binder, thus preparing a slurry.

Examples of the binder may include polytetrafluoroethylene (PTFE), polyvinylidene fluoride (PVDF), NAFION, etc.

Depending on the kind and amount of binder and solvent (which is used to dissolve the binder and is subsequently volatilized, and includes a solvent such as isopropylalchol, etc.), the slurry may have different viscosities. A process of applying a catalyst layer on a diffusion layer may vary depending on the viscosity of the slurry.

A typical example of the carbon support includes a spherical carbon support, such as activated carbon, etc., and any carbon support may be used so long as it has a structure which enables inflow of air and has electrical conductivity.

The mixing ratio of the composite catalyst of the invention, the carbon support and the binder is determined by a typical electrode manufacture example.

2. Forming Catalyst Layer

Below is a description of a variety of processes for forming a catalyst layer which constitutes the cathode. Among the listed processes, any one process may be adopted, and thereby the catalyst layer may be formed from the above slurry on the cathode (a first diffusion layer of the cathode). In addition, other processes known to those skilled in the art may be utilized.

(1) A process of forming a catalyst layer on a cathode using a roll press or a hot press.

(2) A process of forming a catalyst layer using a doctor blade or a roller coater.

(3) A process of forming a catalyst layer using electrospinning.

(4) A process of forming a catalyst layer using electrospraying.

A better understanding of the present invention may be obtained via the following examples which are set forth to illustrate, but are not to be construed as limiting the present invention.

### Example 1

### Preparation of Catalyst

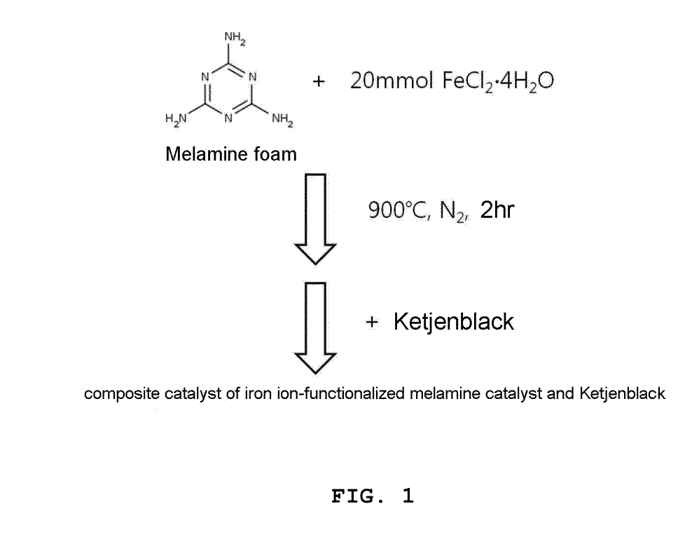

FIG. 1 illustrates a process of preparing a composite catalyst of iron ion-functionalized melamine foam and ketjen black, according to an embodiment of the present invention. The illustrated method is as follows.

1. Cutting a commercially available melamine foam (available from BASF) to a size of about 50 mm*50 mm*40 mm.

2. Preparing a 10 mM FeCl₂.4H₂O aqueous solution.

3. Immersing the prepared melamine foam in 50 ml of the aqueous solution of No. 2 so as to be sufficiently wet.

4. Sufficiently drying the melamine foam wet with the iron ion aqueous solution at 40° C. for 24 hr.

5. Thermally treating the melamine foam in a tube furnace at 900° C. in a nitrogen atmosphere for about 2 hr.

6. Mixing 0.3 g of the carbonized melamine foam and 0.3 g of ketjen black, thus preparing a final catalyst.

### Test Example 1

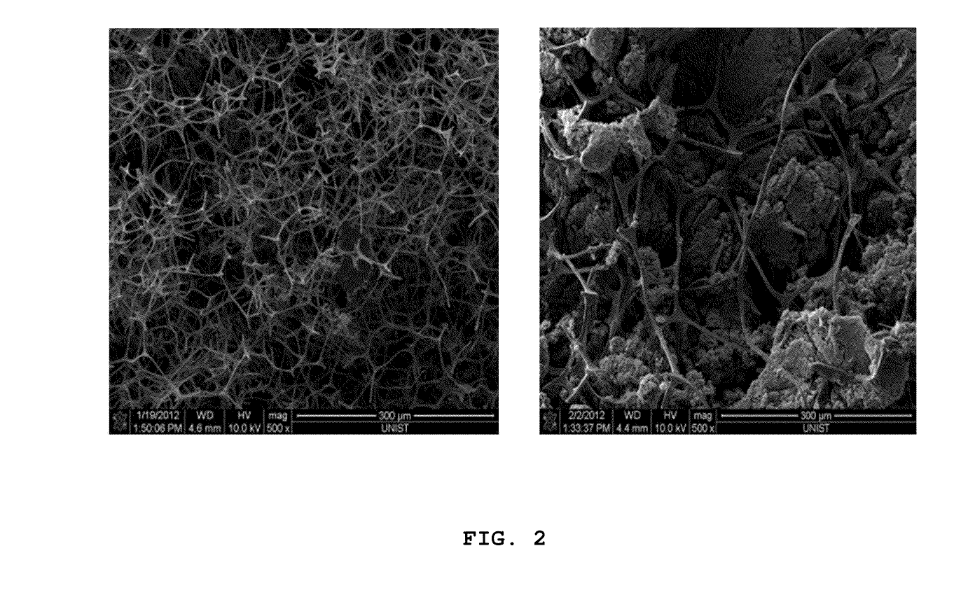

FIG. 2 illustrates SEM images of the composite catalyst prepared according to the embodiment of the present invention, wherein the left image illustrates the carbonized iron ion-functionalized melamine foam, and the right image illustrates the prepared composite catalyst of melamine foam and ketjen black.

As is apparent from these SEM images, the carbonized melamine foam (left) and the ketjen black mixed in the carbonized melamine foam (right) may be shown.

### Test Example 2

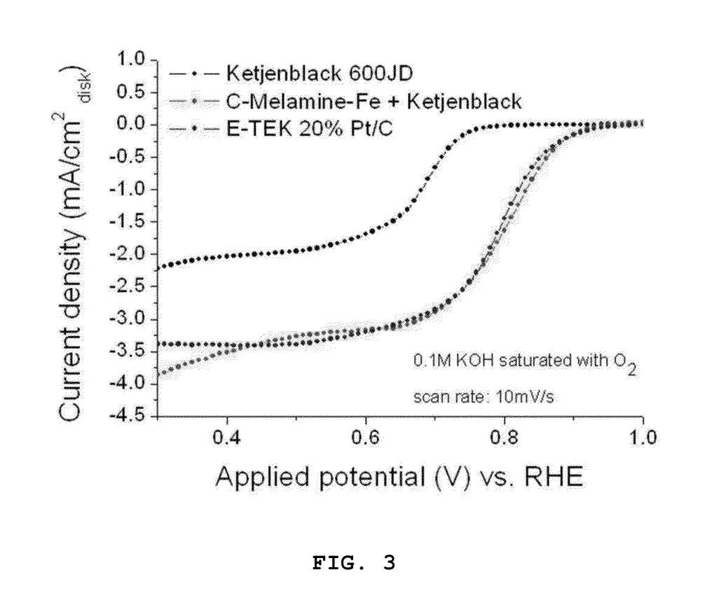

FIG. 3 illustrates a graph of linear sweep voltammetry of the catalyst prepared in an oxygen saturation atmosphere according to the embodiment of the present invention.

While the sweep voltage was changed from 0 V to 1.0 V at about 10 mV/s, current was measured. The case where the absolute value of current is large indicates superior electrochemical performance, and thus the composite catalyst using ketjen black according to the present invention can be seen to exhibit higher performance, compared to other catalysts.

As illustrated in the drawing, the catalyst according to the present invention manifested performance similar to that of the platinum catalyst.

As described hereinbefore, the present invention provides a method of preparing an oxygen reduction reaction catalyst, an oxygen reduction reaction catalyst prepared thereby, and an electrode for a metal-air battery using the oxygen reduction reaction catalyst. According to the present invention, a melamine foam which is commercially available is introduced with transition metal ions in an aqueous solution, and burned at high temperature in a nitrogen atmosphere in a simple one-pot reaction, thus easily forming carbon-nitrogen-transition metal corresponding to the effective catalyst reaction sites, and carbon black as a conductive carbon is simply physically placed in the three-dimensional macropores of the carbonized melamine foam, thereby preparing the oxygen reduction reaction catalyst. The catalyst according to the present invention is advantageous because necessary materials are very inexpensive, mass production is possible and the synthesis process is very simple. Moreover, the prepared catalyst can exhibit performance similar to that of a platinum catalyst as a noble metal catalyst, thus expecting high industrial applicability.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. An oxygen reduction reaction catalyst, comprising:
a melamine foam support containing carbonized transition metal ions; and
carbon black supported on the melamine foam support.

2. The oxygen reduction reaction catalyst of claim 1, comprising 50-80 wt % of the melamine foam support containing carbonized transition metal ions and 20-50 wt % of the carbon black.

3. The oxygen reduction reaction catalyst of claim 1, wherein the transition metal ions are contained in an amount of 1-10 wt % based on total wt % of a carbonized melamine foam.

4. The oxygen reduction reaction catalyst of claim 1, wherein the transition metal ions are iron ions or cobalt ions.

5. The oxygen reduction reaction catalyst of claim 4, wherein the iron ions are formed by carbonizing an iron ion complex aqueous solution including any one or more selected from among FeCl₂.4H₂O, FeCl₃.6H₂O and Fe(NO₃)₃.6H₂O in the melamine foam.

6. The oxygen reduction reaction catalyst of claim 4, wherein the cobalt ions are formed by carbonizing a cobalt ion complex aqueous solution including any one or more selected from among Co(NO₃)₂.6H₂O and Co(C₂H₃O₂)₂ in the melamine foam.

7. The oxygen reduction reaction catalyst of claim 1, wherein the carbon black includes one or more selected from among denka black, acetylene black, ketjen black, furnace black, thermal black and lamp black.

8. An electrode for a metal-air battery, comprising the oxygen reduction reaction catalyst of claim 1, activated carbon and a binder, which are mixed together.

9. The electrode of claim 8, wherein an anode of the metal-air battery includes zinc or lithium.

10. A method of preparing an oxygen reduction reaction catalyst, comprising:
a) preparing a melamine foam;
b) preparing a transition metal ion complex aqueous solution;
c) impregnating the melamine foam with the transition metal ion complex aqueous solution;
d) drying the melamine foam impregnated with the transition metal ion complex aqueous solution;
e) thermally treating the dried melamine foam in an inert gas atmosphere so as to be carbonized; and
f) mixing the carbonized melamine foam with carbon black, thus preparing a final catalyst.

11. The method of claim 10, wherein f) is performed by mixing 50-80 wt % of a melamine foam support containing carbonized transition metal ions and 20-50 wt % of carbon black.

12. The method of claim 10, wherein transition metal ions are contained in an amount of 1-10 wt % based on total wt % of the carbonized melamine foam.

13. The method of claim 10, wherein d) is performed by drying the impregnated melamine foam at 40-50° C. for 24 hr or longer.

14. The method of claim 10, wherein e) is performed by carbonizing the dried melamine foam at 600-900° C. for 1-2 hr in an inert gas atmosphere.

15. The method of claim 10, wherein the transition metal ion complex aqueous solution is an iron ion complex aqueous solution or a cobalt ion complex aqueous solution.

16. The method of claim 10, wherein the iron ion complex aqueous solution includes any one or more selected from among FeCl₂.4H₂O, FeCl₃.6H₂O and Fe(NO₃)₃.6H₂O.

17. The method of claim 10, wherein the cobalt ion complex aqueous solution includes any one or more selected from among Co(NO₃)₂.6H₂O and Co(C₂H₃O₂)₂.

18. The method of claim 10, wherein the carbon black includes one or more selected from among denka black, acetylene black, ketjen black, furnace black, thermal black and lamp black.
